(19) United States
(12) Patent Application Publication
(10) Pub. No.: US 2004/0221727 A1
(43) Pub. Date: Nov. 11, 2004

(54) Bread maker

(75) Inventors: Jae-ryong Park, Suwon-city (KR); Yong-hyun Kwon, Suwon-city (KR); Chul Kim, Anyang-city (KR); Tae-uk Lee, Suwon-city (KR); Han-jun Sung, Suwon-city (KR); Jang-woo Lee, Suwon-city (KR); Dong-bin Lim, Suwon-city (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/755,672

(22) Filed: Jan. 13, 2004

(30) Foreign Application Priority Data
May 7, 2003 (KR) 2003-29085

(51) Int. Cl. A23L 1/00

(52) U.S. Cl. 99/348

(57) ABSTRACT

A bread maker having a main body divided into an oven compartment and a component compartment; and upper and lower kneading drums which rotate, being spaced from each other at upper and lower parts inside of the oven compartment and wind opposite ends of a mixing bag filled with raw materials to make bread and including a driving motor provided inside of the component compartment to rotate one of the upper and lower kneading drums; a pair of sprockets rotatably combining with the upper and lower kneading drums, respectively; and a chain which rotates the upper and lower kneading drums by engaging with the pair of sprockets. Thus, the upper and lower kneading drums linked through the chain are rotatable with a uniform speed, and the raw materials filling in the mixing bag are uniformly kneadable.

### CROSS-REFERENCE TO RELATED APPLICATION

This application claims the benefit of Korean Patent Application No. 2003-29085, filed May 7, 2003, in the Korean Intellectual Property Office, the disclosure of which is incorporated herein by reference.

### BACKGROUND OF THE INVENTION

1. Field of the Invention

The present invention relates to a bread maker, and more particularly, to a bread maker in which a pair of kneading drums is smoothly rotatable.

2. Description of the Related Art

Conventionally, various bread makers have been developed to allow a user to easily make a bread by automatically performing multiple operations such as kneading, leavening and baking of raw materials to provide a finished bread to the user.

For example, a bread maker disclosed in Korean Patent Publication No. 1991-10203 includes a pair of parallel kneading drums which are disposed at upper and lower parts of an oven compartment and rotated in clockwise and counterclockwise directions; a baking tray being placed between the pair of parallel kneading drums; and a heater to heat an inside of the oven compartment.

In the bread maker, opposite ends of a mixing bag filled with the raw materials to make a bread, such as flour and baking powder, are wound by the pair of the parallel kneading drums and then the mixing bag reciprocates in upward and downward directions for a predetermined period of time, so that the raw materials to make the bread in the mixing bag are kneaded.

Thereafter, a cutting unit cuts the mixing bag, so that only the kneaded dough moves into the baking tray. Then, the heater heats the inside of the oven compartment, so that the bread is made in the baking tray by leavening and baking the dough for a predetermined period of time.

To get well-kneaded uniform dough from raw the materials filling the mixing bag, the pair of kneading drums should rotate harmoniously with each other, and the pair of kneading drums should reciprocate the mixing bag in the upward and downward directions, repetitively. Thus, a unit to rotate the kneading drums, which not only makes a rotation of the kneading drums smoothly but also has a good durability, so that the raw materials filling the mixing bag is uniformly kneadable is required.

### SUMMARY OF THE INVENTION

Accordingly, it is an aspect of the present invention to provide a bread maker in which a pair of kneading drums is smoothly rotatable.

Additional aspects and/or advantages of the invention will be set forth in part in the description which follows and, in part, will be obvious from the description, or may be learned by practice of the invention.

The above and/or other aspects are achieved by providing a bread maker comprising: a main body divided into an oven compartment and a component compartment; and upper and lower kneading drums which rotate, being spaced from each other at upper and lower parts inside of the oven compartment, and wind opposite ends of a mixing bag filled with raw materials to make bread; a driving motor provided inside of the component compartment to rotate one of the upper and lower kneading drums; a pair of sprockets rotatably combined with the upper and lower kneading drums, respectively; and a chain which rotates the upper and lower kneading drums by engaging with the pair of sprockets.

According to an aspect, a driving shaft part which is rotatably supported on a first sidewall of the component compartment and rotatably combined with the pair of sprockets is provided at one end of each of the upper and lower kneading drums, and a supporting shaft part which is rotatably supported on a second sidewall of the component compartment is provided at the another of each of the upper and lower kneading drums.

### BRIEF DESCRIPTION OF THE DRAWINGS

These and/or other aspects and advantages of the invention will become apparent and more readily appreciated from the following description of the embodiment, taken in conjunction with the accompanying drawings of which:

FIG. 1 is a perspective view of a bread maker of an embodiment of the present invention;

FIG. 2 is an enlarged cut-away perspective view of a component compartment of FIG. 1;

FIG. 3 is an exploded perspective view showing a driving shaft part and a drum driving part combined with an upper kneading drum of FIG. 2.

### DETAILED DESCRIPTION OF THE PREFERRED EMBODIMENT

Reference will now be made in detail to the embodiment of the present invention, examples of which are illustrated in the accompanying drawings, wherein like reference numerals refer to like elements throughout. The embodiment is described below in order to explain the present invention by referring to the figures.

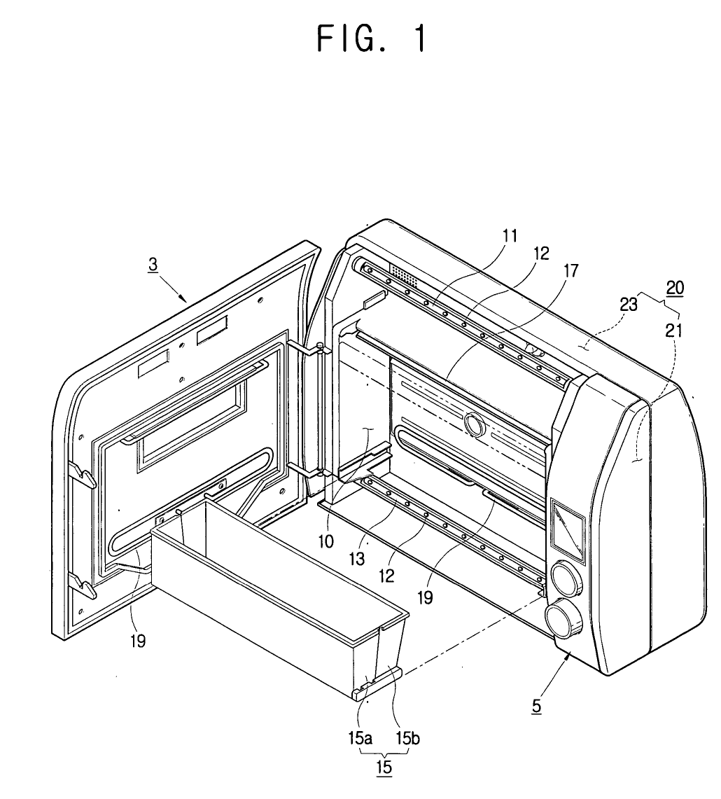

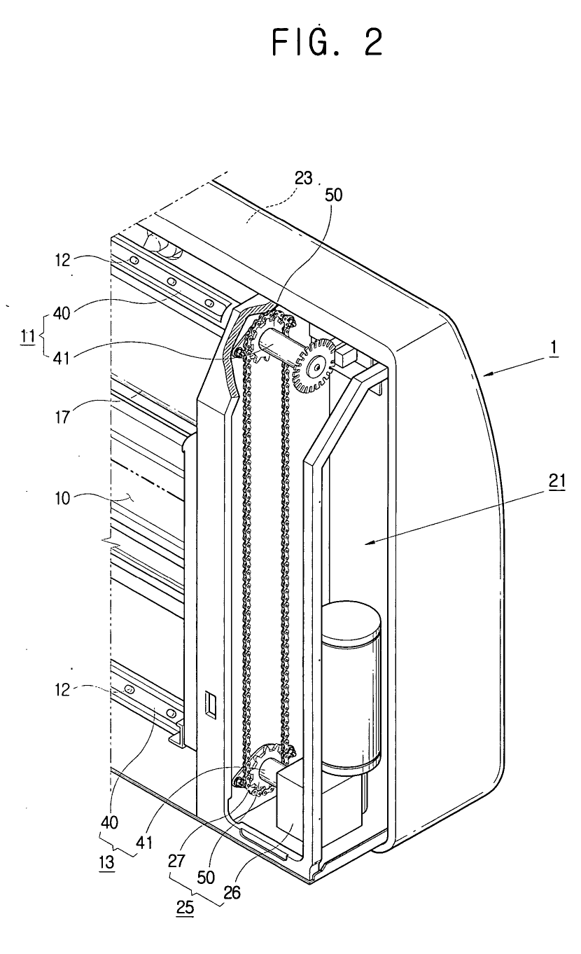

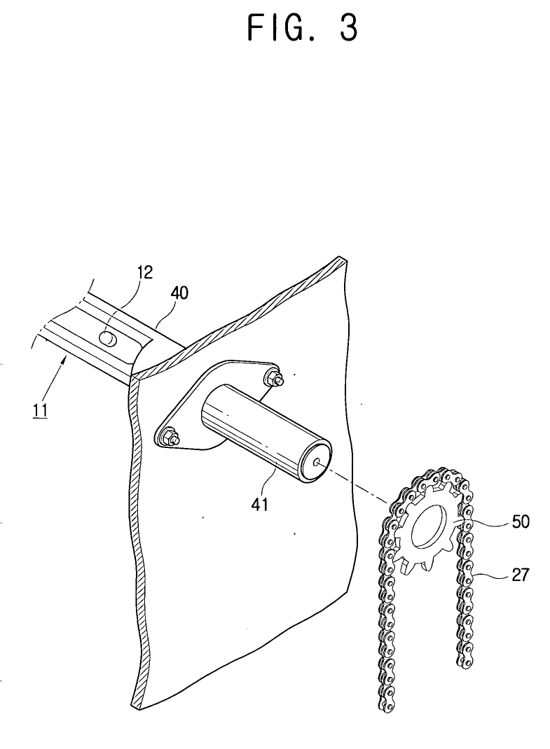

FIG. 1 is a perspective view of a bread maker of an embodiment of the present invention, FIG. 2 is an enlarged cut-away perspective view of a component compartment of FIG. 1, and FIG. 3 is an exploded perspective view illustrating a driving shaft part 41 and a drum driving part 25 combined with an upper kneading drum 11 of FIG. 2. As shown in FIGS. 1-3, a bread maker comprises: a main body 1 divided into an oven compartment 10 and a component compartment 20; a door 3 in a front of the main body 1 to open and to close a front opening of the oven compartment 10; and an operation display panel 5 in a front side of the main body 1 to display an operation state of the main body 1.

In upper and lower parts inside of the oven compartment 10 are placed upper and lower kneading drums 11 and 13 which are rotatably disposed in parallel to wind a predetermined length of opposite ends of a mixing bag (not shown) filled with raw materials to make bread in clockwise and counterclockwise directions. In a lower part of the oven compartment 10, a baking tray 15 to contain kneaded materials therein is provided between the upper and lower kneading drums 11 and 13. Between the upper kneading drum 11 and the baking tray 15 is placed a pair of dough-blocking members 17 preventing the raw materials kneaded in the mixing bag from being moved toward the upper kneading drum 11.

The upper and lower kneading drums 11 and 13 have a substantially common shape and comprises: a drum main body 40 which is formed along a longitudinal direction thereof with a plurality of holding projections 12 to insert in holding holes formed at end parts of the mixing bag; the driving shaft part 41 which extends outward from one end of the drum main body 40 and is rotatably supported on a wall of a first component compartment 21 (to be described later); and a supporting shaft part (not shown) which extends outward from another end of the drum main body 40 and is supported on the inner wall of the oven compartment 10 on an opposite side of the wall supporting the driving shaft part 41 so as to rotate in clockwise and counterclockwise directions.

The baking tray 15 forms a box having a top opening by combining first and second trays 15a and 15b of an “L” shaped section symmetrical to each other.

At upper and lower parts of the rear inner wall of the oven compartment 10 and upper and lower parts of the inside wall of the door 3, baking heaters 19 are provided to heat the inside of the oven compartment 10.

The component compartment 20 includes the first component compartment 21 beside the oven compartment 10 and a second component compartment 23 behind the oven compartment 10. Inside the first component compartment 21 is placed the drum driving part 25 rotating the upper and lower kneading drums 11 and 13 in clockwise and counterclockwise directions.

The drum driving part 25 comprises a driving motor 26 rotating the lower kneading drum 13; a pair of sprockets 50 rotatably combined with the upper and lower kneading drums 11 and 13, respectively; and a chain 27 which engages with the pair of sprockets 50 and co-rotates the upper and lower kneading drums 11 and 13.

The chain 27 is of a closed loop shape and rotates by engaging with the pair of sprockets 50 combined with the upper and lower kneading drums 11 and 13, respectively, when the driving motor 26 operates. The sprockets 50 are formed with toothlike projections on a rim to engage with the chain 27.

With this configuration, one end of the mixing bag is wound by the upper kneading drum 11. Then, the other end of the mixing bag passes through the pair of dough-blocking members 17 and a slit formed at a bottom of the baking tray 15 and is wound by the lower kneading drum 13. A sealed pack filled with the raw materials to make the bread reciprocates in the upward and downward directions between the upper and lower kneading drums 11 and 13 during a kneading process, so that the raw materials to make the bread contained in the mixing bag are kneaded between the pair of dough-blocking members 17 and the baking tray 15. After completing this kneading process, the raw materials to make the bread, separated from the mixing bag, are contained in the baking tray 15, thereby being baked in the baking heater 19.

In the bread maker, the upper and lower kneading drums 11 and 13 are linked through the chain 27 so that the upper and lower kneading drums 11 and 13 are rotatable to knead the mixing bag, and the chain 27 engages with respective sprockets 50 combined with each of the driving shaft parts 41 of the upper and lower kneading drums 11 and 13 without jumping any engaging sequence. Thus, the upper and lower kneading drums 11 and 13 may be rotated more smoothly.

Further, the upper and lower kneading drums 11 and 13 are linked through the chain 27 and the chain 27 does not easily loosen through a repetitive usage for a long period of time, so that a durability of the drum driving part 25 may be facilitated.

As is described above, the chain is rotatable by positively engaging with the sprockets. Thus, the upper and lower kneading drums linked through the chain is rotatable with a uniform speed, so that the raw materials filling in the mixing bag is uniformly kneadable. Further, the chain is used to rotate the upper and lower kneading drums, so that the durability is prolongable.

Although an embodiment of the present invention has been shown and described, it will be appreciated by those skilled in the art that changes may be made in the embodiment without departing from the principles and spirit of the invention, the scope of which is defined in the appended claims and their equivalents.

What is claimed is:

1. A bread maker including a main body divided into an oven compartment and a component compartment; and upper and lower kneading drums which rotate, being spaced from each other at upper and lower parts inside of the oven compartment and wind opposite ends of a mixing bag filled with raw materials to make bread, the bread maker comprising:
a driving motor provided inside of the component compartment to rotate one of the upper and lower kneading drums;
a pair of sprockets rotatably combining with the upper and lower kneading drums, respectively; and
a chain which rotates the upper and lower kneading drums by engaging with the pair of sprockets.

2. The bread maker according to claim 1, further comprising:
a pair of driving shaft parts which are each rotatably supported on a first sidewall of the component compartment and rotatably combined with a respective one of the pair of sprockets at one end of each of the upper and lower kneading drums, and a pair of supporting shaft parts which are each rotatably supported on a second sidewall of the component compartment at another end of the upper and lower kneading drums.

3. A bread maker, comprising:
a main body including upper and lower kneading drums which remotely rotate therein to make bread;
a driving motor provided inside of the main body to rotate the upper and lower kneading drums;
a pair of sprockets rotatably combining with the upper and lower kneading drums, respectively; and
a chain which rotates the upper and lower kneading drums by engaging with the pair of sprockets and rotates by the driving motor.

4. The bread maker according to claim 3, wherein the upper and lower kneading drums, each comprise:
a driving shaft part provided at a corresponding end of a respective one of the upper and lower kneading drums, and a supporting shaft part provided at another corresponding end of the respective one of the upper and lower kneading drums.

5. The bread maker according to claim 4, wherein:
the main body comprises:
oven and component compartments; and
each of the driving shaft parts is rotatably supported on a first sidewall of the component compartment and rotatably combined with the pair of sprockets, and each of the supporting shaft parts is rotatably supported on a second sidewall of the component compartment.

6. The bread maker according to claim 5, further comprising:
heaters; and
a door to selectively open and close an opening of the oven compartment of the main body, wherein the oven compartment of the main body comprises:
a rear inner wall such that, at upper and lower parts of the rear inner wall and at upper and lower parts of an inside wall of the door, the heaters are provided to heat an inside of the oven compartment.

7. The bread maker according to claim 3, wherein the upper and lower kneading drums are rotatably disposed in parallel with each other.

8. The bread maker according to claim 3, further comprising:
a mixing bag to mix dough therein and attached to the upper and lower kneading drums; and
a pair of dough-blocking members to prevent the dough placed in the mixing bag from being moved toward the upper kneading drum.

9. The bread maker according to claim 3, wherein the upper and lower kneading drums have a substantially common shape.

10. The bread maker according to claim 9, wherein each of upper and lower kneading drums comprises:
a drum main body formed along a longitudinal direction thereof with a plurality of holding projections to insert in holding holes formed at end parts of the mixing bag;
driving shaft parts extending outward from one end of the drum main body to drive the upper and lower kneading drums, respectively; and
supporting shaft parts extending outward from another end of the drum main body so as to rotatably support the upper and lower kneading drums.

11. The bread maker according to claim 3, wherein the chain is of a closed loop shape and rotates by engaging with the pair of sprockets, wherein each of the sprockets comprises:
a rim; and
toothlike projections on the rim to engage the chain.

12. The bread maker according to claim 3, wherein the pair of sprockets are linked by the chain to rotate the upper and low kneading drums at a uniform speed.
